(19) United States
(12) Patent Application Publication
(10) Pub. No.: US 2016/0146252 A1
(43) Pub. Date: May 26, 2016

(54) ROLLING-ELEMENT BEARING COMPONENT AND METHOD FOR LOADING A CAGE OF A ROLLING-ELEMENT BEARING WITH ROLLING ELEMENTS

(71) Applicant: Thilo von Schleinitz, Schweinfurt (DE)

(72) Inventor: Thilo von Schleinitz, Schweinfurt (DE)

(73) Assignee: Aktiebolaget SKF, Goteborg (DE)

(21) Appl. No.: 14/947,533

(22) Filed: Nov. 20, 2015

(30) Foreign Application Priority Data
Nov. 20, 2014 (DE) 102014223754.8

(51) Int. Cl. F16C 33/46; F16C 43/06; F16C 19/26

(52) U.S. Cl. CPC F16C 33/4682; F16C 19/26; F16C 43/065

(57) ABSTRACT

A rolling-element bearing component includes a cage and a plurality of rolling elements mounted in the cage. Each of the rolling elements includes a first axial end surface and a second axial end surface and a first recess in the first axial end surface. A first expanding rivet extends through the cage into the first recess of each of the plurality of rolling elements. Also a method of assembling the rolling-element bearing component.

### CROSS-REFERENCE

This application claims priority to German patent application no. DE 10 2014 223 754.8 filed on Nov. 20, 2014, the contents of which are fully incorporated herein by reference.

### TECHNOLOGICAL FIELD

The disclosure relates to a rolling-element component for use in a rolling-element bearing and to a method for loading a cage of a rolling-element bearing with rolling elements.

### BACKGROUND

Rolling-element bearings may include an inner ring, an outer ring, and rolling elements that roll between the inner ring and the outer ring. In many cases the rolling elements are disposed in a cage. There are many ways for assembling a rolling-element bearing, and the method selected will depend on the design of the bearing. Assembly often involves inserting the rolling elements in a cage and then pushing the cage loaded with rolling elements onto an inner ring and/or guiding it into an outer ring. If the weight of the cage loaded with rolling elements is too great, the cage can be pushed onto the inner ring or guided into the outer ring before it is loaded with roller elements. These acts are usually performed with the axis of the cage in a vertical orientation.

After the cage is loaded with rolling elements it is still possible for the rolling elements to fall out of the cage until the rolling-element bearing is fully assembled. One way of preventing this is by using a cage that captively holds the rolling elements. However, this requires the use of a cage that can be temporarily deformed (a snap-type cage). Occasionally solid roller axes are also loaded with hollow-bored rollers and screwed or welded on both sides. This solution is suited for receiving guide forces via the axis and has a high manufacturing cost and a high weight.

### SUMMARY

A first aspect of the present disclosure is to make it possible to efficiently load a cage of a rolling-element bearing with rolling elements with minimal effort even if the rolling elements are not guided by axes.

The disclosure also relates to a rolling-element bearing component comprising a cage and rolling elements. The rolling elements each include a radially outer surface (the rolling surface) that extends between two axial end surfaces. At least one of the axial end surfaces includes a recess. Expanding rivets are attached to the cage and extend into the recesses of the rolling elements.

The disclosure advantageously allows a cage to be loaded with minimal effort. The expanding rivets can be very quickly and easily applied to the cage, and they prevent the rolling elements from falling out of the cage. The expanding rivets do not loosen and can remain connected to the cage throughout its useful life.

The cage can be comprised of one piece or of a plurality of segments. In particular, the cage can be manufactured from steel. The cage is preferably manganese-phosphated.

The expanding rivets can be fixed to the cage with interference-fit. The interference-fit connection is very reliable and durable.

The expanding rivets may each include a sleeve and a pin inserted into the sleeve. In the region of one axial end the sleeve and/or the pin can include at least one axially extending slit and/or a larger regional outer diameter. In the region of the other axial end, the sleeve and/or the pin can have a larger regional outer diameter.

Each axial end of each rolling element includes a recess. An expanding rivet extends into one of the recesses, and either another expanding rivet or a cage projection extends into the recesses at the opposite axial ends of the rolling elements. Using two expanding rivets per rolling element has the advantage that the rolling elements can be very easily inserted into the cage and be held in the same manner on both sides. Using one expanding rivet and one projection has the advantage that only half the number of expanding rivets is needed, and the material costs and assembly costs may thus be lower.

The expanding rivets are disposed relative to the rolling elements so that the rivets and rolling elements do not come into touching contact with each other during operation of the rolling-element bearing. This means that the expanding rivets can be used as assembly and disassembly aids and without affecting the rolling-element bearing during operation. The expanding rivets will not wear during use of the rolling-element bearing and are unlikely to be destroyed by coming into contact with the rolling elements. In addition, the expanding rivets can be offset relative to the axes of the rolling elements so that they are not aligned with the axes of the rolling elements. Furthermore, there can be a touching contact between the rolling elements and the cage. In particular, the cage can be guided by the rolling elements.

The expanding rivets can be manufactured from a plastic material to keep costs low, and expanding rivets of almost any design can be used. In addition, even if material is abraded from the expanding rivets and reaches the rolling-element bearing, the use of a plastic material reduces the risk that this material will damage the rolling-elements. The expanding rivets can be manufactured, for example, from polyamide 6.6 or from polyether ether ketone. These plastics are particularly robust and lubricant-resistant.

The disclosure also relates to a wind turbine including an inventive rolling-element bearing.

Moreover, the invention relates to a method for loading a cage of a rolling-element bearing with rolling elements. In the inventive method the rolling elements are each inserted into the cage and then secured against falling out by at least one expanding rivet per rolling element.

The expanding rivets can each be guided in a through-bore in the cage.

The expanding rivets can each include a sleeve and a pin inserted in the sleeve. The sleeve can be inserted, with the pin partially inserted thereinto, into the through-bore in the cage, and then the pin can be inserted further into the sleeve.

The expanding rivets can be fixed by pressing them into the through-bores in the cage.

In this manner the expanding rivets can be attached to the cage with little effort in a continuous movement.

### BRIEF DESCRIPTION OF THE DRAWINGS

Embodiments of the disclosure are explained below with reference to the exemplary embodiments depicted in the drawings.

FIG. 1 is a schematic side elevational view of a rolling element bearing component comprising a cage and rollers according to an embodiment of the disclosure.

FIG. 2 is a perspective view of the cage FIG. 1 partially loaded with rollers.

FIG. 3 is a perspective view of part of a cage loaded with rollers according to a further embodiment.

FIG. 4 is a sectional side elevational view of components of an expanding rivet usable in the disclosed embodiments.

FIG. 5 is a sectional side elevational view of another component of a rivet usable in the disclosed embodiments.

FIG. 6 is a sectional side elevational view of a preinstalled expanding rivet comprising the components of FIGS. 4 and 5.

FIG. 7 is a sectional side elevational view of the expanding rivet of FIG. 6 inserted a first distance in a bore of the cage of FIG. 1.

FIG. 8 is a sectional side elevational view of the expanding rivet of FIG. 6 inserted a second distance in a bore of the cage of FIG. 1.

FIG. 9 is a sectional side elevational view of the expanding rivet of FIG. 6 fully inserted in a bore of the cage of FIG. 1.

FIG. 10 is a sectional view taken through the cage and one of the rollers of FIG. 2.

FIG. 11 is a sectional view taken through the cage and one of the rollers of FIG. 3.

### DETAILED DESCRIPTION

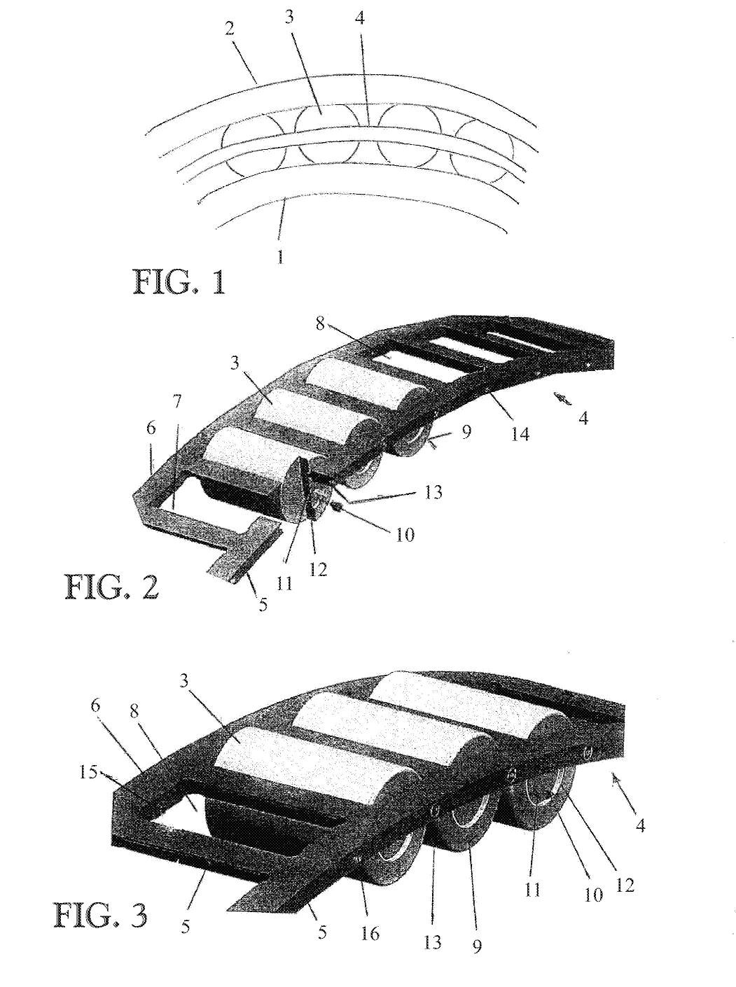

FIG. 1 shows a partial depiction of an exemplary embodiment of a rolling-element bearing according to the disclosure. The rolling-element bearing can be a tapered roller bearing or a cylindrical roller bearing, and, in particular, is well suited for use in a wind turbine. However, uses in other fields are also possible. The rolling-element bearing includes an inner ring 1, an outer ring 2, and rolling elements 3. The rolling elements 3 are guided in a cage 4 and roll between the inner ring 1 and the outer ring 2 in the cage 4.

FIG. 2 shows a partial depiction of an exemplary embodiment of the cage 4 in a perspective view, partially loaded with rolling elements 3. A sectional view through one of the rolling elements 3 is shown in FIG. 10. The cage 4 is a pocket cage and can be described as comprising two side rings 5, 6, and bridges 7 that connect the two side rings 5, 6 to each other. The two side rings 5, 6 and every two successive bridges 7 adjacent in the circumferential direction delimit a pocket 8. A rolling element 3 is disposed in each pocket 8.

The two axial end surfaces 9 the rolling elements 3 each have a recess 10, which recess 10 includes a recess base 11 and a recess edge 12 that surrounds the recess base 11. An expanding rivet 13 projects from the cage 4 into each recess 10; that is the rivet 13 protrudes out of a through-bore 14 in the side ring 5 or 6 towards the rolling element 3. The configuration of the recess 10 and the location of the expanding rivets 13 is selected such that when the rolling-element bearing is fully assembled the expanding rivet 13 does not contact the recess base 11 or the recess edge 12. In the assembled state of the bearing, and in particular in the operating state of the bearing, the expanding rivets 13 thus have no effect on bearing operation. As shall be explained in more detail below, the functionality of the expanding rivets 13 consists of captively fixing the rolling elements 3 in the cage 4. This is of particular significance during assembly of the rolling-element bearing before the cage 4 is placed between the inner ring 1 and the outer ring 2. Without taking any measures to retain the rolling elements 3, they would fall out of the pockets 8 of the cage 4. How the expanding rivets 13 prevent this falling-out and how the expanding rivets 13 are configured is explained in more detail below. It should also be noted that the securing function of the expanding rivets 13 is also of significance during disassembly of the rolling-element bearing and for inspection purposes.

FIG. 3 shows a partial depiction of a further exemplary embodiment of the cage 4, partially loaded with rolling elements 3, in a perspective view. A sectional view through one of the rollers in this cage is shown in FIG. 11. The exemplary embodiment depicted in FIG. 3 substantially corresponds to the exemplary embodiment of FIG. 2. The only effective difference is that in the exemplary embodiment of FIG. 3 only the first side ring 5 includes through-bores 14. The second side ring 6 does not have a through bore 14 and accordingly does not have any expanding rivets 13. Instead, the side ring 6 has a projection 15 in the region of each pocket 8. The projections 15 are each disposed at the circumferential positions of the side ring at which the through bores 14 are formed in the exemplary embodiment of FIG. 2. The projections 15 each extend into a recess 10 of a rolling element 3 and fulfill the same function as the expanding rivets 13, i.e., they secure the rolling elements 3 against falling out of the pockets 8. Accordingly in the fully assembled state of the rolling-element bearing the projections 15 respectively contact neither the recess base 11 nor the recess edge 12.

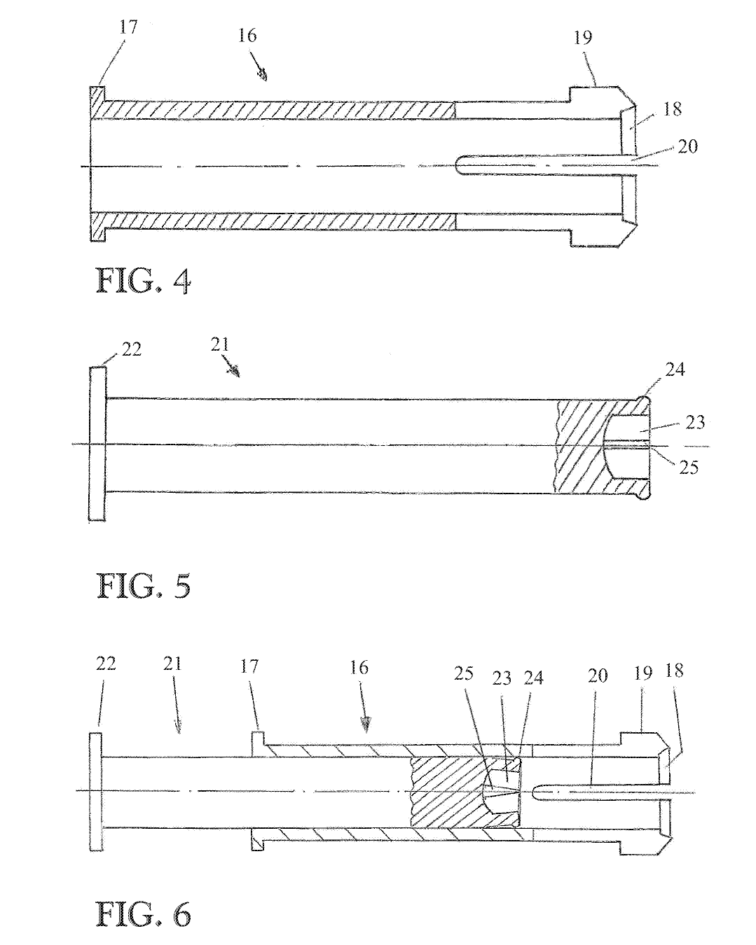

FIG. 4 shows an exemplary embodiment of a component of the expanding rivet 13 in sectional view. The component depicted is a sleeve 16.

The sleeve 16 can be manufactured from metal or plastic. For example, the sleeve 16 can be manufactured from polyamide 6.6 or from polyether ether ketone. The sleeve includes a stop collar 17 in the region of a first axial end that is configured as a radially outwardly projecting flange. The sleeve 16 also includes a countersink 18 in the region of a second axial end. Proceeding from this second axial end a radially outwardly protruding thickening 19 extends over a partial region of the length of the sleeve 16. In addition, starting from the second axial end, axially extending slots 20 (four, for example) extend over a partial region of the length of the sleeve 16. The axial extension of the slots 20 is greater than the axial extension of the thickening 19.

FIG. 5 shows an exemplary embodiment of a further component of the expanding rivet 13 in sectional view. The component depicted in FIG. 5 is a pin 21. The pin 21 can be configured as a solid cylinder and includes a radially outwardly protruding collar 22 in the region of a first axial end. A blind bore 23 is formed in the region of a second axial end. Furthermore, the pin 21 includes a circumferential bead 24 on its outer surface in the region of the second axial end. A slot 25 extends in the axial direction from the second axial end of the pin 21. The axial extension of the slot 25 corresponds approximately to the radial extension of the blind bore 23. The pin 21 can be manufactured from the same material as the sleeve 16.

The cage 4 depicted in FIG. 2 can be loaded with rolling elements 3 as follows:

First, a rolling element 3 is disposed in one of the pockets 8. To facilitate this process, the cage 4 can be clamped beforehand in a tool known for this purpose. The rolling element 3 is disposed in the pocket 8 such that the recess 10 of the rolling element 3 opposes (is aligned with) the through-bores 14 in the side rings 5 and 6.

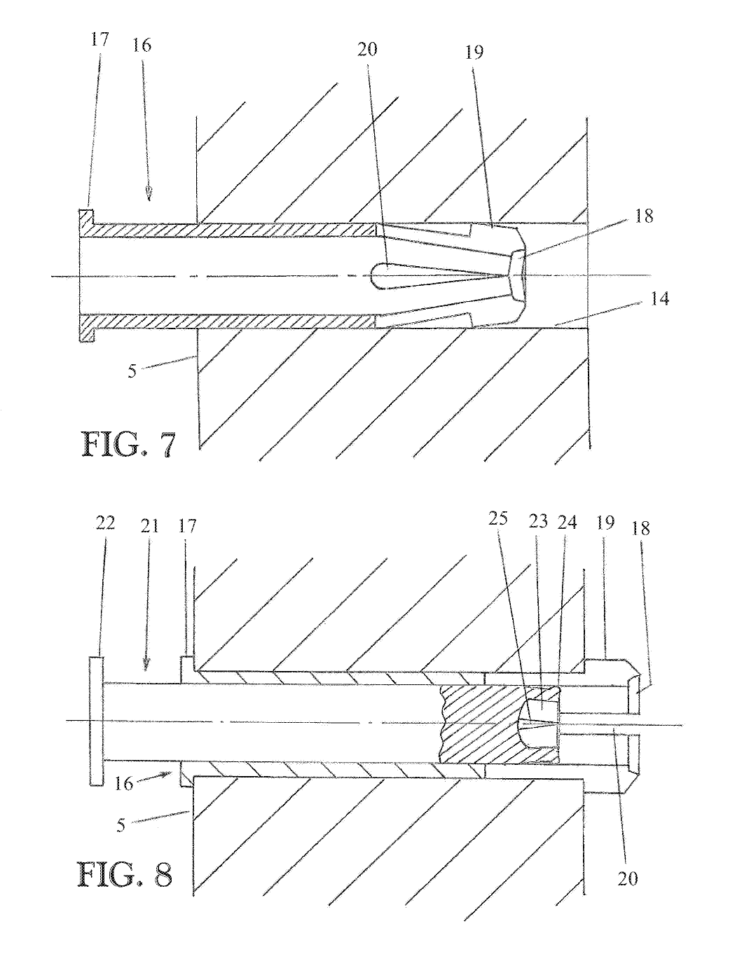

In order to captively fix the rolling elements 3 in the pocket 8 of the cage 4 an expanding rivet 13 is inserted into each through-bore 14 in the side rings 5, 6 and fixed to the side ring 5, 6. Before it is inserted in the through-bore, the expanding rivet 13 is preinstalled in the manner depicted in FIG. 6.

FIG. 6 shows an exemplary embodiment of a preinstalled expanding rivet 13 in sectional view. As can be seen from FIG. 6, the pin 21 is partially inserted into the sleeve 16. When inserting the pin 21 into the sleeve 16, the pin 21 is radially compressed in the region of the bead 24 since the outer diameter of the bead 24 is greater than the inner diameter of the sleeve 16. The radial compression of the pin 21 is made easier because the slot 25 is formed in the region of the bead 24.

It is not necessary to insert the pin 21 into the sleeve 16 precisely to the position depicted in FIG. 6. However, the pin 21 should only be introduced so far into the sleeve 16 that the slotted region of the sleeve 16 can still compress radially inward.

The expanding rivet 13 depicted in FIG. 6 is introduced into the through-bore 14 until the stop collar 17 abuts on the side ring 5, 6 as shown in FIG. 7.

FIG. 7 shows the side ring 5, 6 in the region of the through-bore 14 in sectional view at a first point in time during insertion of the expanding rivet 13. FIG. 8 shows the side ring 5, 6 in the region of the through-bore 14 in sectional view at a second point in time during insertion of the expanding rivet 13. The second point in time is after the first point in time in the method sequence. For reasons of clarity only the sleeve 16, but not the pin 21, is shown in FIG. 7. In fact, however, the pin 21 is located inside the sleeve 16 during the entire inserting process.

The expanding rivet 13 is inserted into the through-opening 14 in the side ring 5, 6 with the axial end of the sleeve 16, on which the countersink 18 is formed, inserted first. Insertion is made easier because the outer surface of the sleeve 16 conically tapers to this axial end. When inserting the expanding rivet 13 into the through-bore 14, the sleeve 16 is radially compressed in the region of the slots 20 since in the uncompressed state the sleeve 16 has an outer diameter in the region of the thickening 19 that is greater than the diameter of the through-bore 14. This is depicted in FIG. 7.

The sleeve 16 is inserted into the through-bore 14 until it abuts with its stop collar 17 on the side ring 5, 6 of the cage 4. Shortly before or at the moment of abutting the thickening 19 of the sleeve 16 has passed the through-bore 14 and exits out the through-bore 14. At this moment the compressed region of the sleeve 16 springs radially outward. The thickening 19 of the sleeve 16, which has a greater outer diameter than the diameter of the through-bore 14, thereby comes into engagement with the side ring 5, 6 and secures the sleeve 16 against being pulled out from the through-bore 14. Simultaneously the stop collar 17 of the sleeve 16 prevents a further penetration of the sleeve 16 into the through-bore 14. The sleeve 16 is thus fixed axially in both directions in the through-bore 14. The fixing can be undone by radially compressing the sleeve 16 in the region of the thickening 19.

FIG. 8 shows the configuration of the expanding rivet 13 at a second point in time, at which the sleeve 16 is fully inserted into the through bore 14 and with its stop collar 17 abutting on one side of the side rings 5, 6 of the cage 4. The pin 21 is only partially inserted into the sleeve 16 so that the collar 22 of the pin 21 has still not contacted the stop collar 17 of the sleeve 16.

For permanently fixing the expanding rivet 13 in the through-bore 14 the pin 21 is inserted further into the sleeve 16 until the collar 22 of the pin 21 abuts against the stop collar 17 of the sleeve 16. At the moment of abutment or directly before, the bead 24 of the pin 21 completely enters into the countersink 18. Since the bore of the sleeve 16 is radially widened in the region of the countersink 18, the bead 24 of the pin 21 springs radially outward when it enters into the counterbore 18 and an interference-fit engagement with the sleeve 16 thus results. This engagement prevents the pin 21 from being pulled out from the sleeve 16. On the other hand, the collar 22 abutting on the stop collar 17 prevents the pin 21 from being inserted further into the housing 16. Overall the pin 21 is thus fixed in the sleeve 16 in an interference-fit manner.

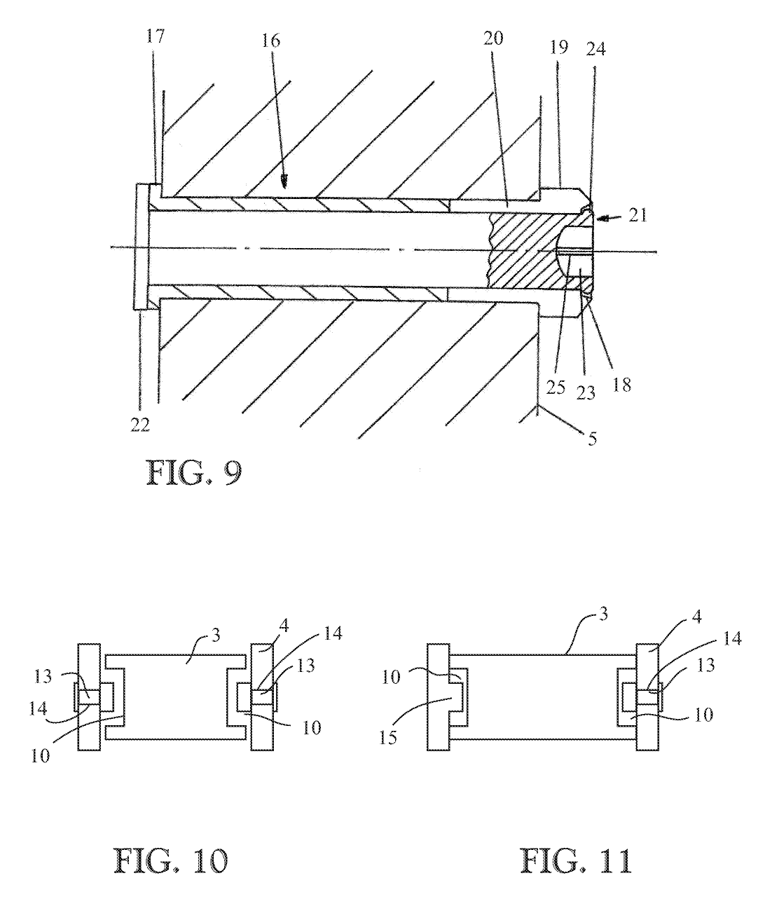

FIG. 9 shows the side rings 5, 6 in the region of the through-bore 14 in sectional view with the expanding rivet 13 fully inserted. Both the interference-fit fixing of the sleeve 16 on side ring 5, 6 and the interference-fit fixing of the pin 21 in the sleeve 21 are visible in FIG. 9. It can further be seen from FIG. 9 that the pin 21 prevents the interference-fit fixing of the sleeve 16 on the side ring 5, 6 from being released since the pin 21 is configured at least partially as a solid cylinder in the region of the thickening 19 of the sleeve 16, and thus compressing the sleeve 16 radially inward in the region of the thickening 19 is not possible. In other words, a non-slotted and non-hollow, and thus non-resilient section of the pin 21 protrudes from the through-bore 14 after assembly and prevents the pin 21 from being released by lateral pressure. Thus the sleeve 16 and consequently the entire expanding rivet 13 is permanently fixed on the side ring 5, 6 of the cage 4.

After being fixed on the side ring 5, 6 the expanding rivet 13 only protrudes from the through-bore 14 on the side facing the rolling elements 3. Here, however, it is preferably set back somewhat with respect to the sleeve 16 in order to prevent the pin 21 from being pressed out of the sleeve 16 by an unintended external influence. On the side facing away from the rolling elements 3 the expanding rivet 13 is flush with the side ring 5, 6 or is somewhat set back relative to the surface of the side ring 5, 6. This is achieved by the through-bore 14 in this region being radially widened (countersunk) such that it can receive the stop collar 17 of the sleeve 16 and the collar 22 of the pin 21. Preferably the stop collar 17 of the sleeve 16 and the collar 22 of the pin 21 have the same outer diameter.

Inserting the expanding rivet 13 into the through-bore 14 up to the final position can occur in a continuous movement. The pin 21 only penetrates completely into the sleeve 16 if the sleeve is completely inserted into the through-bore 14 and snapped in. Thus a fully inserted pin 21 indicates a proper assembly of the expanding rivet 13.

The above-described process is modified slightly in connection with the embodiment of FIG. 3. In this case the rolling element 3 is inserted slightly obliquely into one of the pockets 8 of the cage 4, and one of the recesses 10 of the rolling element 3 is slipped over the adjacent projection 15 of the side ring 6. Then the rolling element 3 in the pocket 8 of the cage 4 is aligned such that its other recess 10 opposes (is aligned with) the through-bore 14 in the side ring 5. Thereafter an expanding rivet 13 is fixed in the through-bore 14 in the side ring 5 in the manner described above.

In a variant of the expanding rivet 13, the sleeve 16 is drawn radially inward in the region of the thickening 19 such that the thickening 19 does not protrude radially beyond the outer surface of the sleeve 16. In addition the bore of the sleeve 16 tapers in the region of the thickening 19. This has the consequence that the thickening 19 of the housing 16 first comes into engagement with the side ring 5, 6 by the inserting of the pin 21. A further property of this variant is that the pin 21 is clamped by the recoiling thickening 19 of the sleeve 16.

The expansion rivet 13 can also be modified such that the pin 21 snaps in into the sleeve on the side of the side ring 5, 6 facing away from the rolling element 3. For this purpose the sleeve 16 can include an encircling inner groove in this region, into which a corresponding radial bulge of the pin 21 snaps in.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved rolling element bearings and associated methods.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Inner ring
2 Outer ring
3 Rolling element
4 Cage
5 Side ring
6 Side ring
7 Bridge
8 Pocket
9 Axial end surface
10 Recess
11 Recess base
12 Recess edge
13 Expansion rivet
14 Through-bore
15 Projection
16 Sleeve
17 Stop collar
18 Countersink
19 Thickening
20 Slot
21 Pin
22 Collar
23 Blind-hole bore
24 Bead
25 Slot

1. A rolling-element bearing component comprising:
a cage; and
a plurality of rolling elements mounted in the cage,
wherein each of the rolling elements includes a first axial end surface and a second axial end surface and a first recess in the first axial end surface, and
wherein a first rivet extends through the cage into the first recess of each of the plurality of rolling elements.

2. The component according to claim 1, wherein the first rivet is an expanding rivet.

3. The component according to claim 2, wherein the first expanding rivets are fixed to the cage in an interference-fit manner.

4. The component according to claim 2, wherein the second axial end surfaces of the plurality of rivets each include a second recess and wherein a second expanding rivet extends through the cage into the second recess of each of the plurality of rolling elements.

5. The component according to claim 2, wherein the second axial end surfaces of the rivets each include a second recess and wherein a projection integral with the cage extends from the cage into the second recess of each of the plurality of rolling elements.

6. The component according to claim 2, wherein the first expanding rivets are disposed relative to the plurality of rolling elements such that there is no touching contact between the first expanding rivets and the plurality of rolling elements.

7. The component according to claim 2, wherein the first expanding rivets are manufactured from a plastic material.

8. The component according to claim 2,
wherein the first expanding rivets are fixed to the cage in an interference-fit manner,
wherein the second axial end surface includes a second recess, and a projection extends from the cage into the second recess of each of the plurality of rolling elements,
wherein the first expanding rivets are disposed relative to the plurality of rolling elements such that there is no touching contact between the first expanding rivets and the plurality of rolling elements, and
wherein the first expanding rivets are manufactured from a plastic material.

9. A rolling element bearing comprising:
an inner bearing ring;
an outer bearing ring; and
a rolling element component according to claim 2.

10. A wind turbine including a rolling-element bearing according to claim 8.

11. A method for loading a rolling-element bearing cage with a plurality of rolling elements comprising:
placing one of the plurality of rolling elements in a pocket of the cage; and
inserting an expanding rivet through the cage such that an end of the expanding rivet projects into a recess in an axial end surface of the rolling element.

12. The method according to claim 11, wherein the cage includes at least one through-bore and wherein inserting the expanding rivet comprises inserting the expanding rivet through the through-bore.

13. The method according to claim 12, wherein the expanding rivets comprise a sleeve into which a pin is insertable, and the sleeve with partially inserted pin is inserted into the through-bore, and then the pin is inserted further into the sleeve.

14. The method according to claim 12, wherein the expanding rivets are fixed by pressing-in into the through-bore.

15. The method according to claim 11, wherein inserting the expanding rivet through the cage comprises inserting the expanding rivet through the cage such that an end of the expanding rivet projects into a recess in an axial end surface of the rolling element without contacting the rolling element.
